(19) United States
(12) Patent Application Publication
(10) Pub. No.: US 2026/0068797 A1
(43) Pub. Date: Mar. 12, 2026

(54) Agricultural Harvesting Device

(71) Applicant: CLAAS Saulgau GmbH, Bad Saulgau (DE)

(72) Inventors: Stefan Birkhofer, Stockach (DE); Stefan Sauter, Zwiefalten (DE)

(21) Appl. No.: 19/313,612

(22) Filed: Aug. 28, 2025

(30) Foreign Application Priority Data
Sep. 10, 2024 (DE) 102024126014.9

(51) Int. Cl. A01B 59/042

(52) U.S. Cl. CPC A01B 59/042

(57) ABSTRACT

Agricultural harvesting device (10), having a drawbar (11) which is able to be coupled to a framework or a frame of the harvesting device (10) on which a plurality of hydraulically actuatable apparatuses such as hydraulic cylinders and/or hydraulic motors engage, having a coupling bracket (12) by way of which the harvesting device (10) is able to be coupled to a towing vehicle for pulling by the towing vehicle, wherein the drawbar (11) is pivotable relative to the coupling bracket (12) about a pivot axis (14), having a bevel gear (18) which engages on the coupling bracket (12) and on the drive side is able to be coupled to a PTO shaft of the towing vehicle by way of an articulated shaft (17), and on the output side is coupled by way of an output shaft (19) to a transfer case (20) engaging on the drawbar (11), by way of which transfer case (20) a plurality of hydraulic pumps (21) that engage on the drawbar (11) are able to be driven so as to supply the hydraulically actuatable apparatuses with hydraulic oil, wherein the transfer case (20) has a gear housing (22), wherein gearwheels of the transfer case (20) are disposed in the gear housing (22), and wherein the gear housing (22) is able to be passed through by a flow of hydraulic oil, specifically downstream of a hydraulic oil reservoir and upstream of the hydraulic pumps. FIG. 3

The invention relates to an agricultural harvesting device.

Agricultural harvesting devices that can be coupled to a towing vehicle in order to be able to be propelled by being pulled with the aid of the towing vehicle, thus pulled by the towing vehicle, are known in practice. Such agricultural harvesting devices, moved by being pulled by a towing vehicle, include in particular forage harvesting devices, for example windrowers or tedders.

A plurality of hydraulically actuatable apparatuses such as hydraulic cylinders and/or hydraulic motors are typically fastened to such an agricultural harvesting device, specifically to a framework or frame of the latter. This is the case in particular with harvesting devices designed as mergers or pickup belt rakes, in which the pickups as well as the transport belts are driven with the aid of hydraulic motors. The hydraulically actuatable apparatuses have to be safely and reliably supplied with hydraulic oil.

Proceeding therefrom, the present invention is based on the object of providing an agricultural harvesting device of which the hydraulically actuatable apparatuses can be safely and reliably supplied with hydraulic oil.

This object is achieved by an agricultural harvesting device according to Claim 1.

The agricultural harvesting device according to the invention has a drawbar which is able to be coupled to a framework or a frame of the harvesting device on which a plurality of hydraulically actuatable apparatuses such as hydraulic cylinders and/or hydraulic motors engage.

The agricultural harvesting device according to the invention furthermore has a coupling bracket by way of which the harvesting device is able to be coupled to a towing vehicle for pulling by the towing vehicle, wherein the drawbar is pivotable relative to the coupling bracket about a pivot axis.

The agricultural harvesting device according to the invention furthermore has a bevel gear which engages on the coupling bracket and on the drive side is able to be coupled to a PTO shaft of the towing vehicle by way of an articulated shaft, and on the output side is coupled by way of an output shaft to a transfer case engaging on the drawbar, by way of which transfer case a plurality of hydraulic pumps that engage on the drawbar are able to be driven so as to supply the hydraulically actuatable apparatuses with hydraulic oil.

The transfer case of the agricultural harvesting device according to the invention has a gear housing, wherein gearwheels of the transfer case are disposed in the gear housing, and wherein the gear housing is able to be passed through by a flow of hydraulic oil, specifically downstream of a hydraulic oil reservoir of the harvesting device and upstream of the hydraulic pumps of the harvesting device.

In the agricultural harvesting device according to the invention, the hydraulically actuatable apparatuses thereof, proceeding from the hydraulic pumps, can be safely and reliably supplied with hydraulic oil. Because the transfer case and the hydraulic pumps engage on the drawbar of the agricultural harvesting device, or are fastened to said drawbar, there is no relative movement between these functional groups during operation, and thus also no movement of hydraulic hoses which are utilized for conveying the hydraulic oil in the direction towards the hydraulic pumps, and proceeding from the hydraulic pumps in the direction towards the hydraulically actuatable apparatuses.

The gear housing of the transfer case preferably has a first chamber in which gearwheels of the transfer case are disposed, wherein the gear housing of the transfer case furthermore has a second chamber which is able to be passed through by a flow of hydraulic oil.

The second chamber, which is able to be passed through by a flow of hydraulic oil, preferably has at least two outlets to which hydraulic pumps are connectable. Particularly preferably, the second chamber, which is able to be passed through by a flow of hydraulic oil, has a separate outlet for hydraulic oil or hydraulic fluid for each hydraulic pump.

Owing to the fact that the second chamber, which is able to be passed through by a flow of hydraulic oil, is accommodated in the gear housing, a separate oil manifold can particularly advantageously be dispensed with, installation space being saved as a result.

In particular, the first chamber of the gear housing of the transfer case and the second chamber of the gear housing of the transfer case are coupled in terms of the fluid flow, in particular in such a manner that the hydraulic oil flowing by way of the gear housing of the transfer case to the hydraulic pumps, and proceeding from the gear housing, distributed to the hydraulic pumps for cooling and/or lubricating the transfer case flows by way of the gearwheels of the transfer case. This is particularly preferable in order not only to utilize the hydraulic oil for actuating the hydraulically actuatable apparatuses, but additionally also for cooling and/or lubricating the transfer case.

The articulated shaft engaging on the bevel gear preferably extends perpendicularly to the output shaft engaging on the bevel gear. The output shaft engaging on the bevel gear extends coaxially with the pivot axis between the drawbar and the coupling bracket. It can also be ensured in this way that no relative movement between the transfer case and the hydraulic pumps arises during operation.

The hydraulic pumps preferably engage on the drawbar below the gear housing. This embodiment is particularly space-saving and ensures that no relative movement between the transfer case and the hydraulic pumps arises during operation.

The agricultural harvesting device is preferably a forage harvester, in particular a merger or pickup belt rake. The invention is used in particular in a merger or pickup belt rake.

Preferred refinements of the invention are derived from the dependent claims and from the description hereunder. Exemplary embodiments of the invention will be explained in more detail by means of the drawings, the invention not being limited thereto. In the drawings:

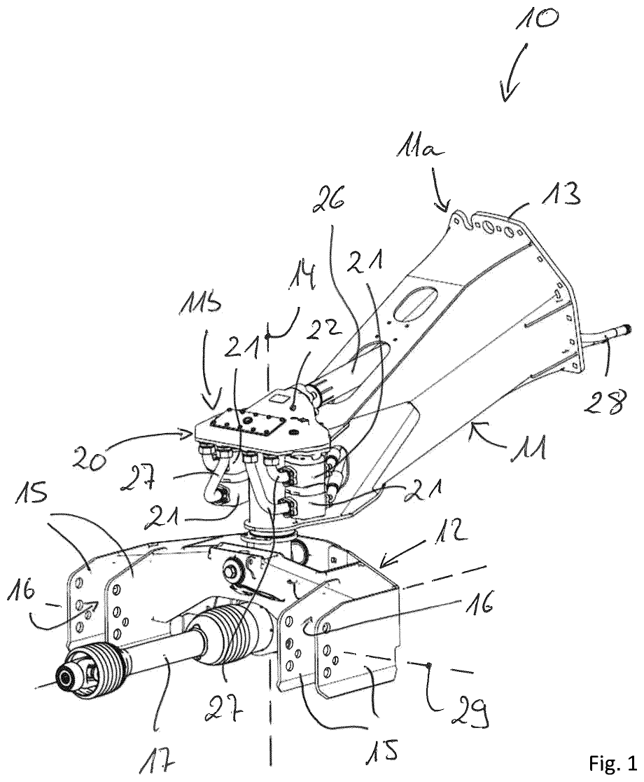

FIG. 1 shows a perspective view of a fragment of an agricultural harvesting device in the region of a drawbar and of a coupling bracket;

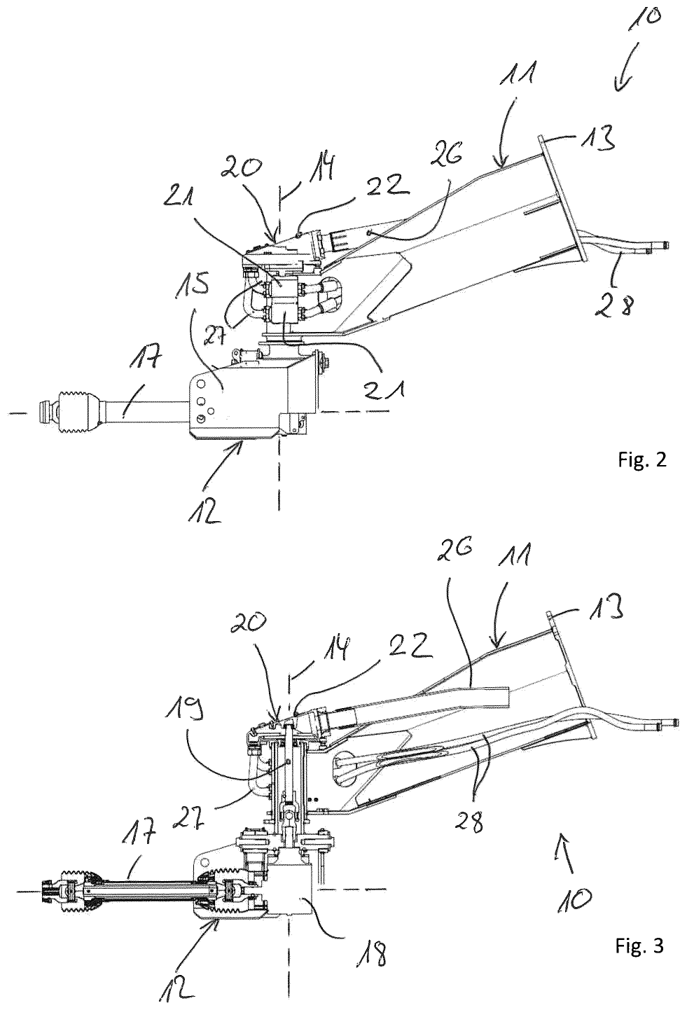

FIG. 2 shows a lateral view of the agricultural harvesting device of FIG. 1;

FIG. 3 shows a cross section through FIG. 2;

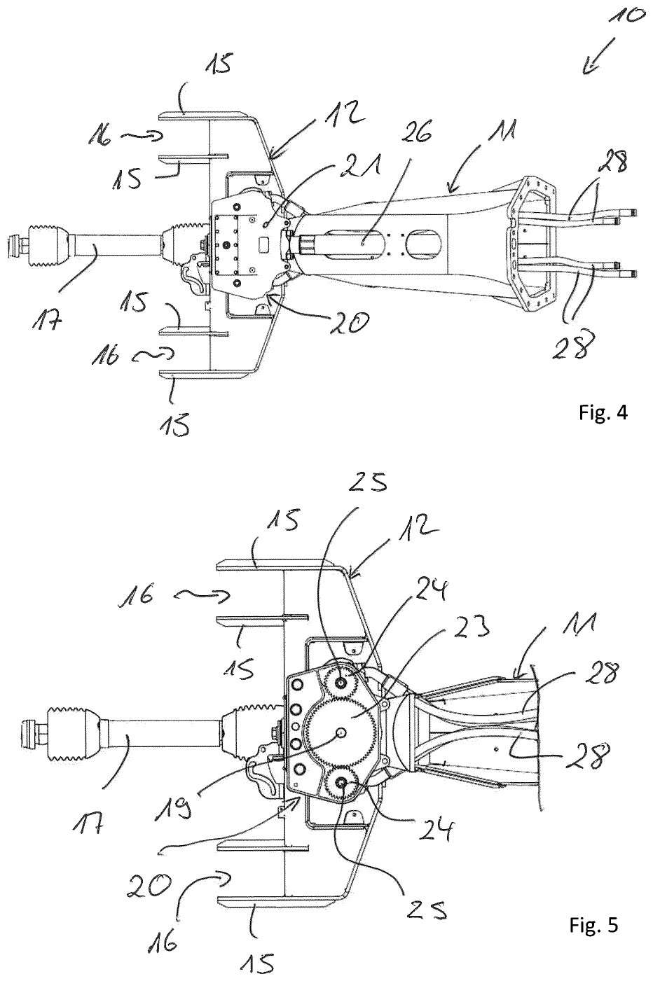

FIG. 4 shows a plan view of the agricultural harvesting device of FIG. 1;

FIG. 5 shows a cross section through FIG. 4.

The present invention relates to an agricultural harvesting device 10. The agricultural harvesting device 10 is in particular a forage harvester which in order to be propelled by being pulled by a towing vehicle can be coupled to a towing vehicle.

FIG. 1 shows a fragment of the agricultural harvesting device 10 according to the invention in the region of a drawbar 11 and of a coupling bracket 12. The drawbar 11 has on a first end 11a a flange 13 by way of which the drawbar 13 is able to be coupled to a framework or frame (not shown) of the harvesting device 10.

A plurality of hydraulically actuatable apparatuses (not shown), which are hydraulic cylinders and/or hydraulic motors and which are supplied with hydraulic oil in order to operate, engage on the framework or frame of the harvesting device 10.

On a second end 11b of the drawbar 11, lying opposite the first end 11a, the drawbar 11 is pivotably connected to the coupling bracket 12. A pivot axis 14 between the drawbar 13 and the coupling bracket 14 extends in the vertical direction.

The coupling bracket 12 serves to couple the harvesting device 10 to a towing vehicle (not shown), in order to pull the harvesting device 10 by the towing vehicle. For coupling the harvesting device 10 to the towing vehicle (not shown), lower links, not shown, of the towing vehicle are able to be introduced into pockets 16 formed between lugs 15 of the coupling bracket 12. During operation, a relative movement between the lower links of the towing vehicle and the coupling bracket 12 about an axis 29 is possible, the latter extending horizontally in the transverse direction of the harvesting device 10, or perpendicularly to a towing direction of the harvesting device 10, respectively.

Besides this mechanical coupling of the harvesting device 10 to the towing vehicle by way of the coupling bracket 12, the harvesting device 10 is able to be coupled on the drive side to the towing vehicle (not shown), specifically to a PTO shaft, not shown, of the towing vehicle, by way of an articulated shaft 17. The articulated shaft 17 extends horizontally in the longitudinal direction of the harvesting device 10, or in the towing direction of the harvesting device 10, respectively.

A bevel gear 18 (see FIG. 3) engages on the coupling bracket 12. The bevel gear 18 is on the drive side able to be coupled to the PTO shaft, not shown, of the towing vehicle, not shown, by way of the articulated shaft 17. On the output side, the bevel gear 18 is coupled by way of an output shaft 19 to a transfer case 20 which engages on the drawbar 11, or is fixedly connected to the drawbar 11, respectively. A plurality of hydraulic pumps 21 that engage on the drawbar 11, or are fixedly connected to the drawbar 11, respectively, can be driven by way of the transfer case 20 in order to supply the hydraulic apparatuses (not shown) of the agricultural harvesting device 10 with hydraulic oil.

The transfer case 20 here has a gear housing 22, wherein gearwheels 23, 24 are disposed in the gear housing 22. The gearwheel 23 sits directly on the output shaft 19 and meshes with the gearwheels 24 which in turn sit on shafts 25 of the hydraulic pumps 21.

The gear housing 22 of the transfer case 20 is passed through by a flow of hydraulic oil, specifically downstream of a hydraulic oil reservoir, not shown, of the agricultural harvesting device 10, and upstream of the hydraulic pumps 21. Hydraulic oil can be retrieved from the hydraulic oil reservoir, not shown, of the agricultural harvesting device 10 by way of a hose or a main hydraulic line 26, specifically be inducted by way of the hydraulic pumps 21 so as to flow upstream of the hydraulic pumps 21 by way of the gear housing 22 of the transfer case 21. First hoses or hydraulic lines 27 extend between the gear housing 22 of the transfer case 20 and the hydraulic pumps 21. Second hoses or hydraulic lines 28 extend from the hydraulic pumps 21 in the direction toward the hydraulically actuatable apparatuses, not shown, of the agricultural harvesting device 10.

The articulated shaft 17 which engages on the bevel gear 18 preferably extends perpendicularly to the output shaft 19 which engages likewise on the bevel gear 18 as well as on the transfer case 20.

As can best be derived from FIG. 3, the output shaft 19 which engages on the bevel gear 18 extends coaxially with the pivot axis 14 between the drawbar 11 and the coupling bracket 12.

In the exemplary embodiment shown, the hydraulic pumps 21 are fastened to the drawbar 11 below the gear housing 22 and thus below the transfer case 20.

During operation, no relative movements between the hydraulic pumps 21, the hoses or hydraulic lines 26, 27, 28 and the drawbar 11 arise.

As already explained, the gear housing 22 serves to receive the gearwheels 23, 24 of the transfer case 20, on the one hand, and to allow the hydraulic oil retrieved from the hydraulic oil reservoir (not shown) of the agricultural harvesting device 10 to flow in the direction towards the hydraulic pumps 21 and to be distributed among the latter, on the other hand. The gear housing 22 of the transfer case 20 here preferably has a first chamber in which the gearwheels 23, 24 are disposed, and furthermore a second chamber which is passed through by a flow of hydraulic oil upstream of the hydraulic pumps 21.

In order to divide or distribute the hydraulic oil among or to the hydraulic pumps 21, respectively, the gear housing 22 in this exemplary embodiment has four outlets which are in each case fluidically connected to a hydraulic pump 21 by way of hydraulic lines in the form of pipes or hoses.

In a first variant, the first chamber of the gear housing 22 which serves to receive the gearwheels 23, 24 of the transfer case 20, and the second chamber of the gear housing 22 which is passed through by a flow of hydraulic oil, can be separated in terms of the fluid flow.

In a second, preferred variant, the first chamber of the gear housing 22 of the transfer case 20 and the second chamber of the gear housing 22 of the transfer case 20 are coupled in terms of the fluid flow, specifically in such a manner that the hydraulic oil flowing by way of the gear housing 22 of the transfer case 20 to the hydraulic pumps 21 and, proceeding from the gear housing 22, distributed to the hydraulic pumps 21 for cooling and/or lubricating the transfer case 20, flows by way of the gearwheels 23, 24 of the transfer case 20.

Accordingly, in the agricultural harvesting device 10 according to the invention, the hydraulic pumps 21 are advantageously able to be supplied with hydraulic oil, as are, proceeding from the hydraulic pumps 21, furthermore hydraulically actuatable apparatuses, not shown, of the harvesting device 10. The transfer case 20 which is fastened to the drawbar 11, serves not only to mechanically drive the hydraulic pumps 21 but rather also to distribute the hydraulic oil in the direction towards the hydraulic pumps 21. The hydraulic pumps 21 and the hydraulic lines 26, 27 and 28, or hoses, respectively, are fastened so as to be stationary on the drawbar 11. The bevel gear 18 is fastened to the coupling bracket 12. As has already been explained, the hydraulic pumps 21 are preferably disposed below the transfer case 20.

A multiplicity of hydraulic pumps 21 of an agricultural harvesting device 10 can be reliably operated with the aid of the invention; furthermore, a multiplicity of hydraulically actuatable apparatuses can be reliably supplied with hydraulic oil by way of the hydraulic pumps 21. The entire assembly is space-saving and avoids any relative movement of hoses or hydraulic lines 26, 27, 28 when moving the drawbar 11 relative to the coupling bracket 12.

When required, the four hydraulic pumps 21 shown in the exemplary embodiment could be supplemented with further hydraulic pumps, or else be reduced to fewer pumps.

Temperature sensors, rotational speed sensors or other sensors for measuring oil parameters, and apparatuses for cooling the hydraulic oil or transmission oil, can be integrated into the transfer case 20.

The agricultural harvesting device 10 is preferably a forage harvester, in particular a merger or pickup belt rake. A merger or pickup belt rake has a plurality of pickups which are to be driven by way of hydraulic motors, and has a plurality of belt conveyors which are to be driven by way of hydraulic motors. These hydraulic motors can be reliably supplied with hydraulic oil with the aid of the invention.

### List of Reference Signs

10 Harvesting device
11 Drawbar
11a End
11b End
12 Coupling bracket
13 Flange
14 Pivot axis
15 Lug
16 Receptacle pocket
17 Articulated shaft
18 Bevel gear
19 Output shaft
20 Transfer case
21 Hydraulic pump
22 Housing
23 Gearwheel
24 Gearwheel
25 Shaft
26 Main hydraulic line/hose
27 Hydraulic line/hose
28 Hydraulic line/hose
29 Axis

1. Agricultural harvesting device (10),
having a drawbar (11) which is able to be coupled to a framework or a frame of the harvesting device (10) on which a plurality of hydraulically actuatable apparatuses such as hydraulic cylinders and/or hydraulic motors engage,
having a coupling bracket (12) by way of which the harvesting device (10) is able to be coupled to a towing vehicle for pulling by the towing vehicle, wherein the drawbar (11) is pivotable relative to the coupling bracket (12) about a pivot axis (14),
having a bevel gear (18) which engages on the coupling bracket (12) and on the drive side is able to be coupled to a PTO shaft of the towing vehicle by way of an articulated shaft (17), and on the output side is coupled by way of an output shaft (19) to a transfer case (20) engaging on the drawbar (11), by way of which transfer case (20) a plurality of hydraulic pumps (21) that engage on the drawbar (11) are able to be driven so as to supply the hydraulically actuatable apparatuses with hydraulic oil,
wherein the transfer case (20) has a gear housing (22), wherein gearwheels (23, 24) of the transfer case (20) are disposed in the gear housing (22), and wherein the gear housing (22) is able to be passed through by a flow of hydraulic oil, specifically downstream of a hydraulic oil reservoir and upstream of the hydraulic pumps (21).

2. Agricultural harvesting device (10) according to claim 1, characterized in that the gear housing (22) of the transfer case (20) has a first chamber in which gearwheels (23, 24) of the transfer case are disposed, and in that the gear housing (22) of the transfer case (20) has a second chamber which is able to be passed through by a flow of hydraulic oil.

3. Agricultural harvesting device (10) according to claim 2, characterized in that the gear housing (22), in particular the second chamber which is able to be passed through by a flow of hydraulic oil, has for each hydraulic pump (21) a separate outlet for hydraulic oil, the latter being in each case fluidically connected to a hydraulic pump (21) by way of a hydraulic line.

4. Agricultural harvesting device (10) according to claim 2 or 3, characterized in that the first chamber of the gear housing (22) of the transfer case (20) and the second chamber of the gear housing (22) of the transfer case (20) are separated in terms of the fluid flow.

5. Agricultural harvesting device (10) according to claim 2 or 3, characterized in that the first chamber of the gear housing (22) of the transfer case (20) and the second chamber of the gear housing (22) of the transfer case (20) are coupled in terms of the fluid flow.

6. Agricultural harvesting device (10) according to claim 5, characterized in that the hydraulic oil flowing by way of the gear housing (22) of the transfer case (20) to the hydraulic pumps (21) and, proceeding from the gear housing (22), distributed to the hydraulic pumps (21) for cooling and/or lubricating the transfer case (20), flows by way of the gearwheels (23, 24) of the transfer case (20).

7. Agricultural harvesting device (10) according to one of claims 1 to 6, characterized in that the articulated shaft (17) engaging on the bevel gear (18) extends perpendicularly to the output shaft (19) engaging on the bevel gear (18).

8. Agricultural harvesting device (10) according to one of claims 1 to 7, characterized in that the output shaft (19) engaging on the bevel gear (18) extends coaxially with the pivot axis (14) between the drawbar (11) and the coupling bracket (12).

9. Agricultural harvesting device (10) according to one of claims 1 to 8, characterized in that the hydraulic pumps (21) engage on the drawbar (11) below the gear housing (22) of the transfer case (20).

10. Agricultural harvesting device (10) according to one of claims 1 to 9, characterized in that the same is a forage harvester.

11. Agricultural harvesting device (10) according to claim 9, characterized in that the forage harvester is a merger or a pickup belt rake.
